(19) United States
(12) Patent Application Publication
(10) Pub. No.: US 2025/0167312 A1
(43) Pub. Date: May 22, 2025

(54) BATTERY

(71) Applicant: TOYOTA JIDOSHA KABUSHIKI KAISHA, Toyota-shi (JP)

(72) Inventor: Takuya MATSUYAMA, Miyoshi-shi (JP)

(73) Assignee: TOYOTA JIDOSHA KABUSHIKI KAISHA, Toyota-shi (JP)

(21) Appl. No.: 18/768,452

(22) Filed: Jul. 10, 2024

(30) Foreign Application Priority Data
Nov. 16, 2023 (JP) 2023-194902

(51) Int. Cl. H01M 10/42; H01M 4/02; H01M 4/38; H01M 10/0525; H01M 10/0562; H01M 50/105; H01M 50/474; H01M 50/486

(52) U.S. Cl. CPC H01M 10/4235; H01M 4/386; H01M 10/0525; H01M 10/0562; H01M 50/105; H01M 50/474; H01M 50/486; H01M 2004/027; H01M 2300/0068

(57) ABSTRACT

In the present disclosure, there is provided a battery including an electrode body and a laminate outer encasement covering the electrode body, wherein the electrode body includes a first surface and a second surface opposed to the first surface in a thickness direction, and the battery includes a first buffer member containing a polyurea resin between the first surface and the laminate outer encasement opposed to the first surface in the thickness direction.

### CROSS-REFERENCE TO RELATED APPLICATION

This application claims priority to Japanese Patent Application No. 2023-194902 filed on Nov. 16, 2023, incorporated herein by reference in its entirety.

### BACKGROUND

### 1. Technical Field

The present disclosure relates to a battery.

### 2. Description of Related Art

A battery such as a lithium-ion secondary battery generally includes an electrode body having a cathode current collector, a cathode active material layer, an electrolyte layer, an anode active material layer, and an anode current collector. The electrode body is sealed in an internal space surrounded by an outer encasing material. Japanese Unexamined Patent Application Publication No. 2020-170583 (JP 2020-170583 A) discloses a laminated secondary battery including a laminated electrode body, a soft laminate outer encasement, and a hard laminate outer encasement.

### SUMMARY

When the active material expands and contracts by charging and discharging, the volume of the electrode body changes along with the expansion and contraction. When the volume change of the electrode body is large, the stress applied from the electrode body to the laminate outer encasements also changes. Therefore, the sealing performance of the laminate outer encasements is likely to decrease.

The present disclosure has been made in view of the above circumstances, and it is a main object of the present disclosure to provide a battery in which the volume change of an electrode body along with charging and discharging is suppressed.

1

A battery including an electrode body and a laminate outer encasement that covers the electrode body, in which
the electrode body includes a first surface and a second surface that faces the first surface in a thickness direction, and
the battery includes a first buffer member containing a polyurea resin between the first surface and the laminate outer encasement that faces the first surface in the thickness direction.
   2

The battery according to 1, in which
the battery includes a second buffer member containing a polyurea resin between the second surface and the laminate outer encasement that faces the second surface in the thickness direction.
   3

The battery according to 2, in which:
the battery includes a third buffer member disposed on a side surface of the electrode body and containing a polyurea resin; and
the first buffer member, the second buffer member, and the third buffer member are integrated together.
   4

The battery according to any one of 1 to 3, in which:
the electrode body includes a cathode active material layer, an anode active material layer, and an electrolyte layer disposed between the cathode active material layer and the anode active material layer; and
the anode active material layer contains a Si active material as an anode active material.
   5

The battery according to any one of 1 to 4, in which:
the electrode body includes a cathode active material layer, an anode active material layer, and an electrolyte layer disposed between the cathode active material layer and the anode active material layer; and
the electrolyte layer is a solid electrolyte layer containing a solid electrolyte.

The battery according to the present disclosure has an effect of suppressing the volume change of the electrode body along with charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic plan view illustrating a battery according to the present disclosure;

FIG. 1B is a schematic cross-sectional view illustrating a battery according to the present disclosure;

FIG. 2 is a schematic perspective view illustrating an electrode body in the present disclosure;

FIG. 3A is a schematic cross-sectional view illustrating a battery according to the present disclosure;

FIG. 3B is a schematic cross-sectional view illustrating a battery according to the present disclosure;

FIG. 4A is a schematic cross-sectional view illustrating an electrode body an embodiment of the present disclosure;

FIG. 4B is a schematic cross-sectional view illustrating an electrode body according to the present disclosure; and

FIG. 5 shows the results of the restraint pressure fluctuation test for the batteries obtained in Examples 1 to 3 and Comparative Example 1.

### DETAILED DESCRIPTION OF EMBODIMENTS

Hereinafter, a battery in the present disclosure will be described in detail with reference to the drawings. Each drawing shown below is schematically shown, and the size and shape of each part are appropriately exaggerated for easy understanding. In addition, in the present specification, when expressing a mode in which another member is arranged with respect to a certain member, when simply referred to as “on” or “below”, unless otherwise specified, both cases 1 and 2 are included. In the case of 1, another member is disposed directly above or directly below a certain member so as to be in contact with the certain member. In the case 2, another member is disposed above or below a certain member via another member.

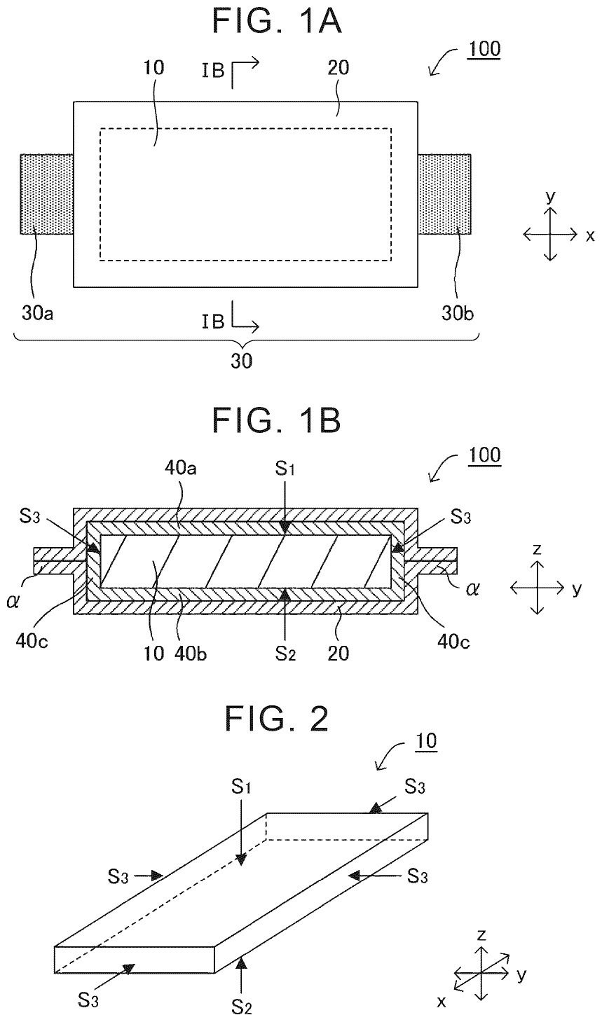

FIG. 1A is a schematic plan view illustrating a battery according to the present disclosure, and FIG. 1B is a cross-sectional view taken along IB-IB of FIG. 1A. The battery 100 shown in FIGS. 1A and 1B has an electrode body 10, a laminate outer encasement 20 covering the electrode body 10, and a terminal 30 electrically connected to the electrode body 10. The electrode body 10 has a first surface S₁, a second surface S₂ opposed to the first surface S₁ in the thickness direction (z direction), and a plurality of third surfaces S₃ corresponding to the side surfaces connecting the first surface S₁ and the second surface S₂. In addition, the battery 100 includes a first buffer member 40a including a polyurea resin at least between the first surface S₁ and the laminate outer encasement 20. Further, as shown in FIG. 1B, a buffer member (first buffer member 40a, second buffer member 40b, and third buffer member 40c) including polyurea resin may be disposed so as to cover the first surface S₁, the second surface S₂, and the third surfaces S₃.

According to the present disclosure, by disposing a buffer member containing a polyurea resin between the electrode body and the laminate outer encasement, a battery in which a change in volume of the electrode body due to charge and discharge is suppressed is obtained. As described above, when the active material expands and contracts due to charging and discharging, the volume of the electrode body also changes with the expansion and contraction. When the volume change of the electrode body is large, the stress applied from the electrode body to the laminate outer encasement also changes, so that the scaling property of the laminate outer encasement tends to deteriorate.

In contrast, in the present disclosure, a cushioning member containing a polyurea resin is disposed between the electrode body and the laminate outer encasement. The polyurea resin has excellent properties such as high elongation, high elasticity, high strength, and high adhesion. Therefore, by disposing a buffer member containing a polyurea resin between the electrode body and the laminate outer encasement, the buffer member absorbs the volume change even when the volume change occurs in the electrode body due to charging and discharging. When the buffer member absorbs the volume change, the stress applied from the electrode body to the laminate outer encasement can be reduced. In addition, the polyurea resin has advantages of high chemical resistance, corrosion resistance, flame retardancy, waterproofness, heat resistance, and abrasion resistance. Further, when a buffer member containing a polyurea resin is produced, for example, spray coating is used, but in this case, there are advantages such as easy coating over a large area, and good workability due to curing within a few minutes.

### 1. Battery Configuration

The battery according to the present disclosure includes at least an electrode body, a laminate outer encasement, and a buffer member.

### (1) Electrode Body

The electrode body according to the present disclosure functions as a power generation element of a battery. Although the configuration of the electrode body is not particularly limited, as shown in FIG. 2, for example, the electrode body has a first surface S₁, a second surface S₂ opposed to the first surface S₁, and a plurality of third surfaces S₃ corresponding to the side surfaces connecting the first surface S₁ and the second surface S₂. For the sake of convenience, a description of tabs used for connecting to terminals is omitted in FIG. 2. The first surface S₁ and the second surface S₂ all correspond to the main surface of the electrode body, and the normal direction of the main surface is defined as the thickness direction (z direction).

The shape of the first surface in plan view is not particularly limited, and examples thereof include squares such as a square, a rectangle, a diamond, a trapezoid, and a parallelogram. In FIG. 2, the first surface S₁ has a rectangular shape in plan view. The shape of the first surface may be a polygon other than a quadrangle, or may be a shape having a curve such as a circle. The shape of the second surface in plan view is the same as the shape of the first surface. The shape of the third surface in plan view is not particularly limited, and examples thereof include squares such as a square, a rectangle, a diamond, a trapezoid, and a parallelogram.

### (2) Cushioning Member

The cushioning member in the present disclosure contains a polyurea resin and is disposed between the electrode body and the laminate outer encasement.

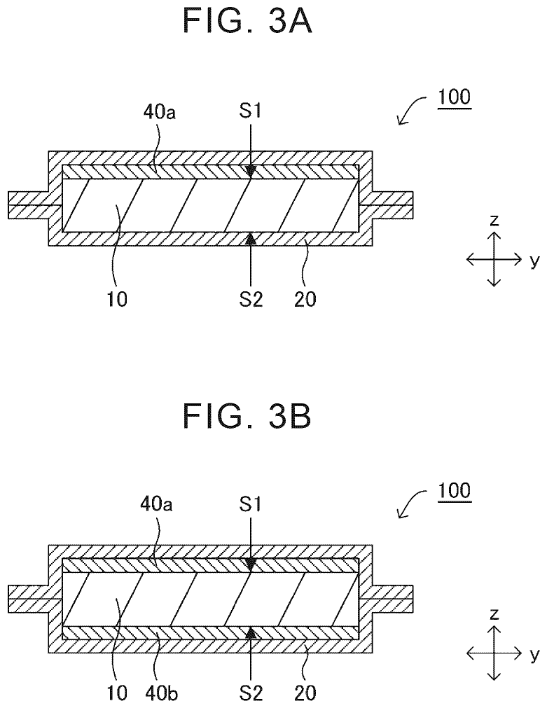

As shown in FIG. 3A, the first buffer member 40a may be disposed between the first surface S₁ of the electrode body 10 and the laminate outer encasement 20 facing the first surface S₁. By disposing the first buffer member 40a, it is possible to suppress a change in volume of the electrode body caused by charging and discharging in the thickness direction (z direction). In addition, in FIG. 3A, the buffer member is not disposed between the second surface S₂ of the electrode body 10 and the laminate outer encasement 20 facing the second surface S₂.

As shown in FIG. 3B, the first buffer member 40a may be disposed between the first surface S₁ of the electrode body 10 and the laminate outer encasement 20 facing the first surface S₁. Further, as shown in FIG. 3B, the second buffer member 40b may be disposed between the second surface S₂ of the electrode body 10 and the laminate outer encasement 20 facing the second surface S₂. By arranging the first buffer member 40a and the second buffer member 40b, it is possible to further suppress a volume change of the electrode body caused by charging and discharging in the thickness direction (z direction). In addition, in FIG. 3B, the first buffer member 40a and the second buffer member 40b are separate members.

As shown in FIG. 1B, the first buffer member 40a may be disposed between the first surface S₁ of the electrode body 10 and the laminate outer encasement 20 facing the first surface S₁. Further, as shown in FIG. 1B, the second buffer member 40b may be disposed between the second surface S₂ of the electrode body 10 and the laminate outer encasement 20 facing the second surface S₂. As shown in FIG. 1B, the third buffer member 40c may be disposed between the third surface S₃ of the electrode body 10 and the laminate outer encasement 20 facing the third surface S₃. In FIG. 1B, the first buffer member 40a, the second buffer member 40b, and the third buffer member 40c are integrated. Further, since the third buffer member 40c is connected to the first buffer member 40a and the second buffer member 40b, it is possible to remarkably suppress the volume change of the electrode body caused by charging and discharging in the thickness direction (z direction).

In FIGS. 1A and 1B, the two third buffer members 40c face each other in the y-direction perpendicular to the extending direction (x-direction) of the terminal 30. On the other hand, although not particularly shown, two third buffer members may face each other in the x-direction. In addition, in the present disclosure, an integral buffer member may be disposed so as to cover the entire surface of the electrode body. Further, the buffer member may be in close contact or not in close contact, but the former is preferable. This is because, in the thickness direction (z direction), it is possible to further suppress a change in the volume of the electrode body caused by charging and discharging. In particular, the buffer member is preferably a member formed on the surface of the electrode body by spray coating. This is because the adhesiveness of the buffer member and the electrode body is excellent.

### (3) Laminate Outer Encasement

The laminate outer encasement according to the present disclosure is disposed so as to cover the electrode body via the cushioning member. As shown in FIG. 1B, the sealing portion a is formed by welding the laminate outer encasements 20 opposed to each other, and the electrode body 10 is sealed. Further, although not particularly illustrated, the seal portion may be folded. By folding the seal portion a, the sealing property is improved. In addition, in FIG. 1B, the two laminate outer encasements 20 are used to seal the electrode body 10. On the other hand, although not particularly shown, the electrode body may be sealed by bending one laminate outer encasement. As a method of welding the laminate outer encasements to each other, for example, a method of pressing a heat bar against a portion where the laminate outer encasements are superimposed on each other and thermally welding the laminate outer encasements to each other is exemplified.

### 2. Member of Battery

The battery according to the present disclosure includes at least an electrode body, a laminate outer encasement, and a buffer member.

### (1) Cushioning Member

The cushioning member in the present disclosure contains a polyurea resin. The polyurea resin is a resin having a urea bond (—NH—CO—NH—). Examples of the polyurea resin include polyurea and polyurea polyurethane, and among them, polyurea is preferable. Polyureas are generally resins that do not have an urethane bond (—NH—CO—O—), and have the advantage of being less susceptible to hydrolysis than polyurea polyurethanes.

The polyurea is usually obtained by reacting a polyisocyanate with a polyamine. Among them, the polyurea is preferably a resin using only a polyisocyanate and a polyamine as resin raw materials.

A polyisocyanate is a compound having two or more isocyanate groups in one molecule. Examples of the polyisocyanate include diphenylmethane-4,4′-diisocyanate, carbodiimide-modified diphenylmethane diisocyanate, polymethylene polyphenyl isocyanate, 2,4-tolylene diisocyanate, 2,6-tolylene diisocyanate, xylylene diisocyanate, hexamethylene diisocyanate, and 3-isocyanatomethyl-3,5,5-trimethylcyclohexyl isocyanate.

The polyamine is a compound having two or more amino groups (primary amino groups or secondary amino groups) in one molecule. Examples of the polyamine include alkaneamines, aromatic amines, polyether amines, and ethyleneamines. Examples of the alkancamine include ethylenediamine, 1,3-propanediamine, 1,4-butanediamine, 1,3-butanediamine, 1,2-butanediamine, 1,5-pentanediamine, 1,6-hexanediamine, and dimer diamine. Examples of the aromatic amine include o-phenylenediamine, m-phenylenediamine, p-phenylenediamine, 1,5-naphthalenediamine, 1,8-naphthalenediamine, o-xylylenediamine, m-xylylenediamine, and p-xylylenediamine. Examples of the polyetheramine include triethylene glycol diamine, trimethylolpropane poly (oxypropylene) triamine, and methoxypoly (oxyethylene/oxypropylene)-2-propylamine. Examples of the ethyleneamines include diethylenetriamine, triethylenetetramine, and tetraethylenepentamine. The molecular weight of the polyamine is not particularly limited, but is, for example, not less than 50 g/mol and not more than 1000 g/mol.

In the synthesis of the polyurea, additives such as a chain extender, a crosslinking agent, and a catalyst may be used. Examples of the chain extender include amine-based chain extenders.

On the other hand, the polyurea polyurethane may be, for example, a resin obtained by polymerizing a polyisocyanate, a polyamine, and a polyol-based chain extender. The polyurea polyurethane may be, for example, a resin obtained by polymerizing a polyisocyanate, a polyol, and an amine-based chain extender.

The glass transition temperature of the polyurea resin is not particularly limited, but is, for example, −50° C. or more and 250° C. or less. The buffer member preferably contains a polyurea resin as a main component, and more preferably contains only a polyurea resin. The elastic modulus of the resinous member is not particularly limited, but may be, for example, greater than or equal to 5 MPa and less than or equal to 30 MPa, and greater than or equal to 8 MPa and less than or equal to 15 MPa. The fracture strength of the resinous member is, for example, 30 kN/m or higher at 25° C. and may be 40 kN/m or higher. On the other hand, the fracture strength of the resinous member is, for example, 100 kN/m or less at 25° C. The fracture strength of the resinous member is, for example, 80 kN/m or higher at −25° C. and may be 100 kN/m or higher. On the other hand, the fracture strength of the resinous member is, for example, 200 kN/m or less at −25° C. The thickness of the buffer member is not particularly limited, but may be, for example, 0.5 mm or more and 5 mm or less, and may be 0.8 mm or more and 3 mm or less.

### (2) Electrode Body

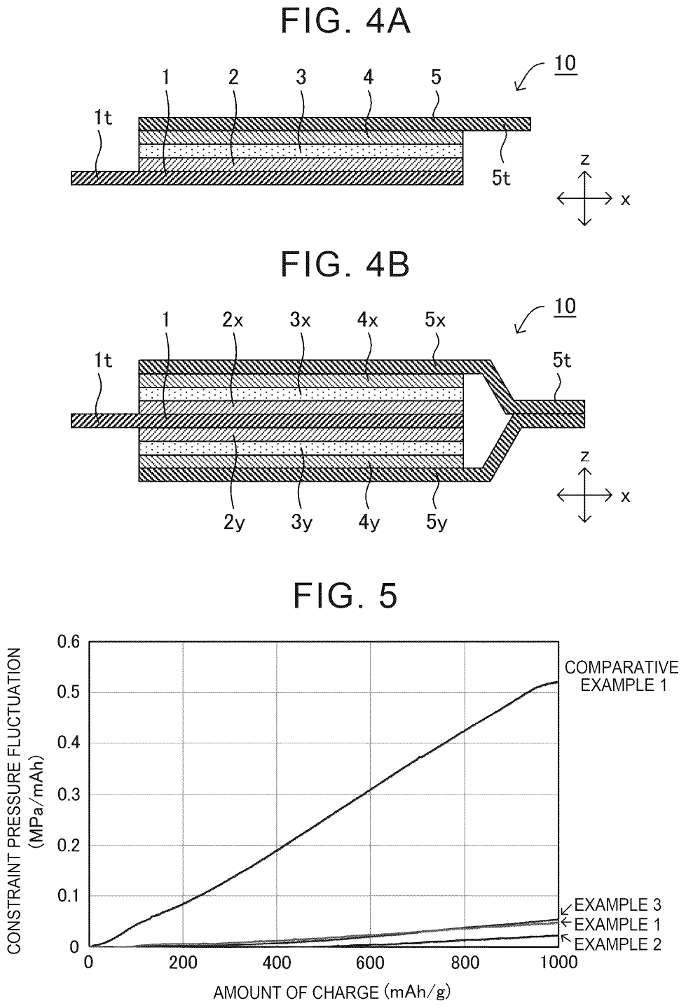

The electrode body in the present disclosure generally includes a cathode current collector, a cathode active material layer, an electrolyte layer, an anode active material layer, and an anode current collector in this order in the thickness direction. FIGS. 4A and 4B are schematic cross-sectional views illustrating an electrode body according to the present disclosure, corresponding to a schematic cross-sectional view of the electrode body according to x-z plane in FIG. 2.

The electrode body 10 shown in FIG. 4A includes an anode current collector 1, an anode active material layer 2, an electrolyte layer 3, a cathode active material layer 4, and a cathode current collector 5 in this order in the thickness direction (z direction). The anode current collector 1 has a negative electrode tab It for connecting to a negative electrode terminal (not shown), and the cathode current collector 5 has a positive electrode tab 5t for connecting to a positive electrode terminal (not shown).

The electrode body 10 shown in FIG. 4B includes an anode current collector 1, an anode active material layer 2x, an electrolyte layer 3x, a cathode active material layer 4x, and a cathode current collector 5x, which are arranged in this order in the thickness direction (z direction) from one surface of the anode current collector 1. The electrode body 10 shown in FIG. 4B includes an anode active material layer 2y, an electrolyte layer 3y, a cathode active material layer 4y, and a cathode current collector 5y, which are arranged in this order in the thickness direction (z direction) from the other surface of the anode current collector 1.

The cathode active material layer contains at least a positive electrode active material. The cathode active material layer may further contain at least one of an electrolyte, a conductive material, and a binder. Examples of the cathode active material include an oxide active material. Examples of the oxide active material include rock salt layered active materials such as LiNi_{1/3}Co_{1/3}Mn_{1/3}O₂, LiNi_{0.8}Co_{0.15}Al_{0.05}O₂, spinel-type active materials such as LiMn₂O₄, and olivine-type active materials such as LiFePO₄. Further, sulfur (S) may be used as the cathode active material. The shape of the cathode active material is, for example, particulate.

The electrolyte may be a solid electrolyte or a liquid electrolyte. The solid electrolyte may be an organic solid electrolyte such as a gel electrolyte or an inorganic solid electrolyte such as a sulfide solid electrolyte or an oxide solid electrolyte. Among them, the solid electrolyte is preferably a sulfide solid electrolyte. This is because the ion conductivity is high.

The sulfide solid-electrolyte usually contains at least an Li element and an S element. It is preferable that the sulfide solid-electrolyte further contain an M element (M is at least one of P, As, Sb, Si, Ge, Sn, B, Al, Ga, and In). The sulfide solid-electrolyte may contain a halogen element such as F, Cl, Br, and I.

The sulfide solid electrolyte may be a glass-based (amorphous-based) sulfide solid electrolyte, a glass-ceramic-based sulfide solid electrolyte, or a crystalline sulfide solid electrolyte. The sulfide solid electrolyte may have a crystalline phase. Examples of the crystalline phase include a Thio-LISICON type crystalline phase, an argyrodite type crystalline phase, and an LGPS type crystalline phase.

Examples of the sulfide solid electrolyte include xLi₂S·(1-x)P₂S₅ (0.5≤x<1), yLiI·zLiBr·(100-y-z)(xLi₂S·(1-x)P₂S₅) (0.5≤x<1, 0≤y≤30, and 0≤z≤30). However, the composition of the sulfide solid electrolyte is not particularly limited. In these compositions, x preferably satisfies 0.7≤x≤0.8. Other examples of the sulfide solid electrolyte include Li_{7-x-2y}PS_{6-x-y}X_{y}. X is at least one of F, Cl, Br, and I, and x and y satisfy 0≤x and 0≤y. Other examples of the sulfide solid electrolyte include Li₄₋ₓM₁₋ₓPₓS₄ (0<x<1). M is at least one of Al, Zn, In, Ge, Si, Sn, Sb, Ga, and Bi.

On the other hand, the liquid electrolyte contains, for example, a support salt such as LiPF₆ and a solvent such as a carbonate-based solvent. Examples of the conductive material include carbon materials. Examples of the binder include a rubber-based binder and a fluoride-based binder.

The anode active material layer contains at least a negative electrode active material. The anode active material layer may further contain at least one of an electrolyte, a conductive material, and a binder. Examples of the anode active material include a metal active material such as Li, Si, and Sn, a carbon active material such as graphite, and an oxide active material such as Li₄Tis₅O₁₂.

The anode active material is preferably an Si active material. This is because it is possible to increase the capacity of the battery. In addition, the Si active material has a large volume change due to charging and discharging, but by using the above-described buffer member, a battery in which the volume change of the electrode body due to charging and discharging is suppressed can be obtained. The Si active material is an active material containing Si as a main component. The Si active material may be an Si alone, may be an Si alloy, or may be an Si oxide. The Si active material may have a diamond-type crystal phase, a clathrate I-type crystal phase, or a clathrate II type crystal phase. In a clathrate type I or II crystalline phase, a polyhedron (cage) including a pentagon or a hexagon is formed by a plurality of Si elements. Since the polyhedron has a space in the interior that can contain metallic ions such as Li ions, volume change due to charging and discharging can be suppressed.

The shape of the anode active material is, for example, a particulate shape or a foil shape. The electrolyte, the conductive material, and the binder are the same as those described above.

The electrolyte layer is disposed between the cathode active material layer and the anode active material layer, and contains at least an electrolyte. The electrolyte may be a solid electrolyte or a liquid electrolyte. The electrolyte is similar to those described above. The electrolyte layer may be a solid electrolyte layer containing a solid electrolyte. Further, the solid electrolyte is preferably a sulfide solid electrolyte. In general, a battery having a solid electrolyte layer containing an inorganic solid electrolyte is referred to as an all-solid-state battery.

The cathode current collector collects current from the cathode active material layer. Examples of the material of the cathode current collector include metals such as aluminum, SUS, and nickel. Examples of the shape of the cathode current collector include a foil shape and a mesh shape. The cathode current collector usually has a positive electrode tab for connection with a positive electrode terminal.

The anode current collector collects current from the anode active material layer. Examples of the material of the anode current collector include metals such as copper, SUS, and nickel. Examples of the shape of the anode current collector include a foil shape and a mesh shape. The anode current collector usually has a negative electrode tab for connection with a negative electrode terminal.

### (3) Laminate Outer Encasement

The laminate outer encasement in the present disclosure has at least a structure in which an inner resin layer and a metal layer are laminated. In addition, the laminate outer encasement may have an inner resin layer, a metal layer, and an outer resin layer in this order along the thickness direction. Examples of the resin layer include olefin-based resins such as polypropylene (PP) and polyethylene (PE). Examples of the material of the metal layer include aluminum, aluminum alloy, and stainless steel. For example, polyethylene terephthalate (PET) or nylon may be used as the outer resin layer. The thickness of the inner resin layer is, for example, 40 μm or more and 100 μm or less. The thickness of the metal layer is, for example, 30 μm or more and 60 μm or less. The thickness of the outer resin layer is, for example, 20 μm or more and 60 μm or less. The thickness of the laminate outer encasement is, for example, 80 μm or more and 250 μm or less.

### (4) Battery

As shown in FIGS. 1A and 1B, the battery 100 has a terminal 30 (a positive electrode terminal 30a and a negative electrode terminal 30b) electrically connected to the electrode body 10. One end of the positive electrode terminal 30a is electrically connected to a positive electrode tab (not shown) of the electrode body 10 inside the laminate outer encasement 20, and the other end of the positive electrode terminal 30a is exposed to the outside of the laminate outer encasement 20. Similarly, one end of the negative electrode terminal 30b is electrically connected to a negative electrode tab (not shown) in the electrode body 10 inside the laminate outer encasement 20, and the other end of the negative electrode terminal 30b is exposed to the outside of the laminate outer encasement 20. The terminal may be made of a metallic material such as SUS.

The battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Also, the battery in the present disclosure may be used as a power source for mobile bodies other than vehicles (for example, railroads, ships, and aircraft), and may be used as a power source for electric products such as an information processing device.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

### EXAMPLE 1

### Preparation of Electrode Body

The cathode active material, the sulfide solid electrolyte, the conductive material, and the binder were weighed so that the cathode active material: sulfide solid electrolyte: conductive material: binder=88.2:9.8:1.3:0.7. The cathode active material has an LiNi_{0.8}Co_{0.15}Al_{0.05}O₂. The sulfide solid electrolyte is a Li₂S—P₂S₅ sulfide solid electrolyte. The conductive material is a vapor deposition carbon fiber. The binder is a PVdF based binder. Next, these materials were agitated together with a dispersion medium (butyl butyrate) by an ultrasonic dispersing apparatus to prepare a positive electrode slurry. Next, the obtained positive electrode slurry was applied to a positive electrode current collector (Al foil) by a blade method, and dried on a hot plate at 100° C. for 30 minutes. Thus, a positive electrode having a cathode current collector and a cathode active material layer was obtained.

Thereafter, the anode active material, the sulfide solid electrolyte, the conductive material, and the binder were weighed so that the anode active material: sulfide solid electrolyte: conductive material: binder=100:77.6:2:15. The anode active material is Si powder. The sulfide solid electrolyte is a Li₂S—P₂S₅ sulfide solid electrolyte. The conductive material is a vapor deposition carbon fiber. The binder is a PVdF based binder. Next, these materials were agitated together with a dispersion medium (butyl butyrate) by an ultrasonic dispersing apparatus to prepare a negative electrode slurry. Next, the obtained negative electrode slurry was applied to an anode current collector (Ni foil) by a blade method, and dried on a hot plate at 100° C. for 30 minutes. Thus, a negative electrode having an anode current collector and an anode active material layer was obtained.

Thereafter, the sulfide solid electrolyte (Li₂S—P₂S₅ sulfide solid electrolyte) and the binder (PVdF binder) were weighed so that the sulfide solid electrolyte: binder=99.4:0.4. Next, these materials were agitated together with a dispersion medium (butyl butyrate) by an ultrasonic dispersing apparatus to prepare a slurry for the solid electrolyte layer. Next, the obtained slurry was applied to a substrate (SUS foil) by a blade method, and dried on a hot plate at 100° C. for 30 minutes. Thus, a transfer member having a base material and a solid electrolyte layer was obtained.

Thereafter, the negative electrode and the transfer member were stacked so that the anode active material layer and the solid electrolyte layer were opposed to each other, and the negative electrode and the transfer member were pressed at 50 kN/cm and 160° C. using a roll press machine. The substrate (SUS foil) was peeled from the pressed laminate. The exposed solid-state electrolyte layer and the cathode active material layer in the positive electrode were opposed to each other and pressed at 20 kN/cm and 160° C. using a roll press machine. Thus, an electrode body was obtained.

### Preparation of Batteries

A positive electrode terminal and a negative electrode terminal were attached to the electrode body, and a polyurea (elastic modulus: 13.7 MPa) was applied to both main surfaces (first surface and second surface) of the electrode body by spray coating to form a first buffer member and a second buffer member. Each of these thicknesses was 1 mm. Thereafter, the electrode body, the first buffer member, and the second buffer member were sealed using a laminate outer encasement (aluminum laminate) to obtain a battery.

### EXAMPLE 2

A battery was obtained in the same manner as in Example 1 except that a buffer member was formed so as to cover the entire surface of the electrode body.

### EXAMPLE 3

Batteries were obtained in the same manner as in Example 1, except that polyurea plates (elastic modulus: 13.7 MPa) in the thickness of 1 mm were arranged on both main surfaces (first surface and second surface) of the electrode body.

### Comparative Example 1

A battery was obtained in the same manner as in Example 1 except that the first buffer member and the second buffer member were not formed.

### Evaluation

Batteries obtained in Examples 1 to 3 and Comparative Example 1 were sandwiched between two restraining plates, tightened with a 5 MPa restraining pressure by a fastener, and the distance between the two restraining plates was fixed. Next, at 1/10 C, constant current charging was performed up to 4.05 V, and then constant voltage charging was performed up to the end current 1/100 C at 4.05 V, and the restraint voltage variation during charging was measured. The effect is shown in FIG. 5. As shown in FIG. 5, it was confirmed that the restraint pressure fluctuations in Examples 1 to 3 were smaller than those in Comparative Example 1. In Example 1, the restraint pressure fluctuation was smaller than that in Example 3, and in Example 2, the restraint pressure fluctuation was smaller than that in Example 1. As described above, it was confirmed that the volume change of the electrode body due to charge and discharge can be suppressed by disposing the buffer member containing the polyurea resin between the electrode body and the laminate outer encasement.

What is claimed is:

1. A battery comprising an electrode body and a laminate outer encasement that covers the electrode body, wherein
the electrode body includes a first surface and a second surface that faces the first surface in a thickness direction, and
the battery includes a first buffer member containing a polyurea resin between the first surface and the laminate outer encasement that faces the first surface in the thickness direction.

2. The battery according to claim 1, wherein the battery includes a second buffer member containing a polyurea resin between the second surface and the laminate outer encasement that faces the second surface in the thickness direction.

3. The battery according to claim 2, wherein:
the battery includes a third buffer member disposed on a side surface of the electrode body and containing a polyurea resin; and
the first buffer member, the second buffer member, and the third buffer member are integrated together.

4. The battery according to claim 1, wherein:
the electrode body includes a cathode active material layer, an anode active material layer, and an electrolyte layer disposed between the cathode active material layer and the anode active material layer; and
the anode active material layer contains a Si active material as an anode active material.

5. The battery according to claim 1, wherein:
the electrode body includes a cathode active material layer, an anode active material layer, and an electrolyte layer disposed between the cathode active material layer and the anode active material layer; and
the electrolyte layer is a solid electrolyte layer containing a solid electrolyte.
